(19) United States
(12) Patent Application Publication
(10) Pub. No.: US 2026/0034919 A1
(43) Pub. Date: Feb. 5, 2026

(54) VEHICLE AND CONTROL METHOD THEREOF

(71) Applicants: Hyundai Motor Company, Seoul (KR); Kia Corporation, Seoul (KR)

(72) Inventors: Jae Hyun Kim, Hwaseong-si (KR); Sang Kyung Seo, Hwaseong-si (KR)

(21) Appl. No.: 19/081,639

(22) Filed: Mar. 17, 2025

(30) Foreign Application Priority Data
Aug. 2, 2024 (KR) 10-2024-0103390

(51) Int. Cl. B60N 2/14; B60N 2/02

(52) U.S. Cl. CPC B60N 2/14; B60N 2/0228; B60N 2/0233; B60N 2/0276; B60N 2/0279

(57) ABSTRACT

A vehicle and a control method thereof are provided. The vehicle may include: at least one seat capable of swiveling; a user interface; and a swivel control device. The swivel control device may be configured to: receive, via the user interface, an indication of a requested swivel mode for the at least one seat; and, control, based on the requested swivel mode and based on a detection of a swivel condition being satisfied, a swivel operation of the at least one seat.

### CROSS-REFERENCE TO RELATED APPLICATION

This application claims priority to and the benefit of Korean Patent Application No. 10-2024-0103390, filed on Aug. 2, 2024, the disclosure of which is incorporated herein by reference in its entirety.

### FIELD

The present disclosure relates to controlling vehicle seats.

### BACKGROUND

Some vehicle seats allow sitting only in a fixed position, thereby limiting them from being used for various purposes. To address this, swivel seats that can be manually rotated are provided in some vehicles, but these seats are still limited in that manually rotating the seat is inconvenient and it is difficult to adjust a swivel angle.

### SUMMARY

The present disclosure is directed to providing a technology for automatically swiveling a vehicle seat in consideration of various conditions.

The problem to be solved by the present disclosure is not limited to the above-mentioned problems, and other problems which are not mentioned will be clearly understood by those skilled in the art from the following description.

According to one or more example embodiments of the present disclosure, a vehicle may include: at least one seat capable of swiveling; a user interface; and a swivel control device configured to: receive, via the user interface, an indication of a requested swivel mode for the at least one seat; and during a driving control operation of the vehicle that is driving on a road, control, based on the requested swivel mode and based on a detection of a swivel condition being satisfied, a swivel operation of the at least one seat.

The swivel condition may include at least one of: autonomous driving of the vehicle, a detection of a collision risk of the vehicle with an external object, a gear position of the vehicle, a speed of the vehicle, a power on or off state of the vehicle, an electric vehicle power mode of the vehicle, a user consent state for swiveling, a seating state of the at least one seat, a previous operation state of the at least one seat, or a preliminary condition of the at least one seat before the swivel operation.

The requested swivel mode may include at least one of: a partial swivel mode for rotating the at least one seat, around a vertical shaft of the at least one seat, by an angle, below a threshold angle, in any one direction relative to a front-facing direction; a full swivel mode for rotating the at least one seat by at least the threshold angle; or a return swivel mode for rotating the at least one seat in the front-facing direction.

The swivel condition may be different for the partial swivel mode, the full swivel mode, and the return swivel mode.

The swivel control device may be configured to control the swivel operation by controlling the swivel operation of the at least one seat differently for the partial swivel mode, the full swivel mode, and the return swivel mode.

The swivel control device may be configured to control the swivel operation of the at least one seat by at least one of: determining, among the at least one seat, a seat to be swiveled, or determining a rotation angle for swiveling the at least one seat.

The swivel control device may be configured to control the swivel operation of the at least one seat by: moving, before the swivel operation of the at least one seat starts and based on the requested swivel mode being one of the full swivel mode or the return swivel mode, the at least one seat or one or more objects adjacent to the at least one seat from a starting position to a first position.

The swivel control device may be configured to control the swivel operation of the at least one seat further by: moving, after the swivel operation of the at least one seat is complete, the at least one seat or the one or more objects from the first position to a second position. The second position may be between the starting position and the first position.

The at least one seat may include a driver's seat in a first row of the vehicle. The one or more objects may include at least one of a steering wheel or a component disposed in a region adjacent to the steering wheel.

The user interface may include at least one of a touch screen or a physical button. At least one of the swivel condition or the swivel operation being controlled may be different based on whether the requested swivel mode is received via the touch screen or the physical button.

At least one of the swivel condition or the swivel operation being controlled may be different based on whether the physical button, via which the requested swivel mode is received, is a driver-side button or a passenger-side button.

The vehicle may further include an indicator configured to visually display content related to the swivel operation. The indicator may be disposed on the physical button or in a region adjacent to the physical button.

According to one or more example embodiments of the present disclosure, a method performed by an apparatus of a vehicle may include: receiving, via a user interface of the vehicle, an indication of a requested swivel mode for at least one seat of the vehicle; controlling driving of the vehicle; and, during a driving control operation of the vehicle that is driving on a road, controlling, based on the requested swivel mode and based on a detection of a swivel condition being satisfied, a swivel operation of the at least one seat. The at least one seat may be capable of swiveling.

The swivel condition may include at least one of: autonomous driving of the vehicle, a detection of a collision risk of the vehicle with an external object, a gear position of the vehicle, a speed of the vehicle, a power on or off state of the vehicle, an electric vehicle power mode of the vehicle, a user consent state for swiveling, a seating state of the at least one seat, a previous operation state of the at least one seat, or a preliminary condition of the at least one seat before the swivel operation.

The requested swivel mode may include at least one of: a partial swivel mode for rotating the at least one seat, around a vertical shaft of the at least one seat, by an angle, below a threshold angle, in any one direction relative to a front-facing direction; a full swivel mode for rotating the at least one seat by at least the threshold angle; or a return swivel mode for rotating the at least one seat in the front-facing direction.

The swivel condition may be different for the partial swivel mode, the full swivel mode, and the return swivel mode.

Controlling the swivel operation may include controlling the swivel operation of the at least one seat differently for the partial swivel mode, the full swivel mode, and the return swivel mode.

Controlling the swivel operation may include: moving, before the swivel operation of the at least one seat starts and based on the requested swivel mode being one of the full swivel mode or the return swivel mode, the at least one seat or one or more objects adjacent to the at least one seat from a starting position to a first position.

Controlling the swivel operation may further include: moving, after the swivel operation of the at least one seat is complete, the at least one seat or the one or more objects from the first position to a second position. The second position may be between the starting position and the first position.

The user interface may include at least one of a touch screen or a physical button. At least one of the swivel condition or the swivel operation being controlled may be different based on whether the requested swivel mode is received via the touch screen or the physical button. At least one of the swivel condition or the swivel operation being controlled may be different based on whether the physical button, via which the requested swivel mode is received, is a driver-side button or a passenger-side button.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a block diagram illustrating a swivel control device of a vehicle;

FIG. 2 is a flowchart of a process of controlling seat swivel driving;

FIG. 3 is a flowchart of a process of determining a seat swivel condition;

FIG. 4 is a flowchart of a process of specifically controlling seat swivel driving;

FIGS. 5 to 8 are exemplary views for describing the operation of a vehicle seat swivel; and

FIG. 9 is a flowchart illustrating a swivel initialization process.

### DETAILED DESCRIPTION

Hereinafter, one or more example embodiments of the present disclosure will be described in detail with reference to the accompanying drawings.

However, the technical spirit of the present disclosure is not limited to the example embodiments to be described, but may be implemented in various different forms, and within the technical spirit of the present disclosure, one or more of the components thereof may be selectively combined and substituted between the example embodiments.

Further, the terms (including technical and scientific terms) used in the example embodiments of the present disclosure may be interpreted as meanings that may be generally understood by those skilled in the art to which the present disclosure belongs, unless specifically defined and described, and terms generally used such as terms defined in advance may be interpreted in consideration of the meaning in the context of the related art.

In addition, the terms used in the example embodiments of the present disclosure are provided not to limit the present disclosure but to describe the example embodiments.

In the present specification, the singular form may include a plural form unless the context clearly indicates otherwise, and when “A and at least one (or one or more) of B and C” is described, it may include one or more of all combinations of A, B, and C.

Further, terms such as first, second, A, B, (a), (b), and the like may be used in describing the components of the example embodiment of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

These terms are only provided to distinguish the components from other components, and the nature, sequence, order, or the like of the corresponding components are not limited by these terms.

Further, when a certain component is described as being ‘connected,’ ‘coupled,’ or ‘connected’ to another component, this may include not only a case where the certain component is directly being connected, coupled, or connected to the other component, but also a case where the certain component is indirectly being connected, coupled, or connected to the other component with another component interposed therebetween.

In addition, when one component is described as being formed or disposed” on or under” another component, the term “on or under” includes not only a case in which two components are in direct contact with each other, but also a case in which one or more other components are formed or disposed between the two components. In addition, when the term “on or under” is expressed, it may mean not only an upward direction but also a downward direction based on one component.

The term “first row” mentioned in the present document may mean a region where a driver's seat and a passenger's seat are located, and the term “second row” and “third row” may respectively mean seats located in that order behind the first row.

The term “swivel” mentioned in the present document means rotation in the direction of an arrow indicated in the drawing of the present document or in the opposite direction toward a specific direction around a vertical axis of the vehicle seat. This swivel means rotating a vehicle seat to change a user's line of sight or to face the user in the rear seat. The swivel may be interpreted differently from the rotation in the direction in which the user folds or tilts the seat upward/downward to change his/her posture.

In the various flowcharts of the present document, at least some of the operations may be omitted or the order of each operation may be changed, and at least some of the various example embodiments of the present document may be performed at a specific time point of each operation of the flowcharts. The various flowcharts of the present document may be executed by at least one of a swivel control device 100, a processor 130, and a computer program.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., an indication of a requested swivel mode of a car seat) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., an indication of a requested swivel mode of a car seat) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., an indication of a requested swivel mode of a car seat) described herein.

Minimum risk maneuver (MRM) operation(s) may also be controlled, for example, based on one or more features (e.g., an indication of a requested swivel mode of a car seat) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., an indication of a requested swivel mode of a car seat) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may include an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., an indication of a requested swivel mode of a car seat) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.). As an example, the full or partial swivel operation of one or more seats may be activated or performed (e.g., automatically performed without a user intervention) during autonomous driving. The full or partial swivel operation of one or more seats may be activated or performed, for example, if a risk of collision of a vehicle with an external object is detected above a threshold level. The automatic swivel operation may reduce a risk of a potential injury to an occupant of the vehicle.

Hereinafter, one or more example embodiments will be described in detail with reference to the accompanying drawings, and the same reference numerals denote the same or corresponding components regardless of the drawing numbers, and redundant descriptions thereof will be omitted.

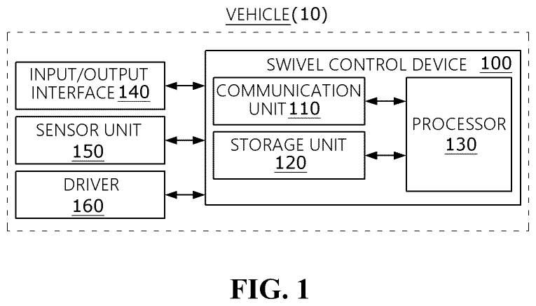

FIG. 1 is a block diagram illustrating a swivel control device 100 of a vehicle 10.

The vehicle 10 may include the swivel control device 100, a communication unit (also referred to as a communication interface) 110, a storage unit (also referred to as storage or data storage) 120, a processor 130, an input/output interface (also referred to as an input and output interface or a user interface) 140, a sensor unit (also referred to as one or more sensors) 150, and a driver 160. Each of the configurations in FIG. 1 may be implemented inside a vehicle.

The swivel control device 100 may be an electronic device or program which performs a function of controlling the swivel driving (also referred to as a swivel motion, a swivel movement, a swivel operation, a swivel control, etc.) of a seat through the components of the vehicle 10. The swivel control device 100 may be integrally formed with the internal components of the vehicle, and may also be implemented as a separate device and connected to the internal components of the vehicle by a separate connection part. The swivel control device 100 is shown as including the communication unit 110, the storage unit 120, and the processor 130, but may be configured by including other components (for example, the input/output interface 140, and the like) of the vehicle 10. The swivel control device 100 may control a driving mechanism, such as a motor or a servomechanism, to cause one or more seats of the vehicle to swivel. The swivel control device 100 may control the driving mechanism to cause the one or more seats to swivel at a specific speed (e.g., rotational speed), a specific acceleration (e.g., angular acceleration), and/or to a specific angular position.

The communication unit 110 may communicate with a user terminal, another vehicle, or an external server. The communication unit 110 may perform short range communication, GPS signal reception, V2X communication, optical communication, broadcast transmission/reception, and intelligent transport systems (ITS) communication functions.

The communication unit 110 may support short-range communication by using at least one of Bluetooth, radio frequency identification (RFID), Infrared Data Association (IrDA), Ultra Wideband (UWB), ZigBee, near field communication (NFC), wireless-fidelity (Wi-Fi), Wi-Fi direct, and wireless universal serial bus (wireless USB) technologies.

The storage unit 120 may store data generated or collected in at least some of the components related to the seat swivel control of the vehicle 10. The storage unit 120 may be provided inside the processor 130 or the swivel control device 100, or may be a separate memory. The storage unit 120 may be composed of a combination of a non-volatile memory such as a hard disk drive, a flash memory, an electrically erasable programmable read-only memory (EEPROM), a static random access memory (SRAM), a ferro-electric RAM (FRAM), a phase-change RAM (PRAM), a magnetic RAM (MRAM), and the like, and/or a volatile memory such as a dynamic random access memory (DRAM), a synchronous dynamic random access memory (SDRAM), a double rate-SDRAM (DDR-SDRAM), and the like.

The processor 130 may be electrically or operatively connected to the communication unit 110, the storage unit 120, the input/output interface 140, the sensor unit 150, the driver 160, and various internal components of the vehicle 10, may electrically or operatively control each component, may be an electric circuit which executes software commands, and may perform various types of data processing and calculations to be described below.

The processor 130 may process a signal transmitted between the components of the vehicle 10, and may perform overall control so that each of the components may normally perform its function. The processor 130 may be implemented in a form of hardware, software, or a combination of the hardware and the software.

The input/output interface 140 may include an input part for receiving a control command from a user and an output part for outputting the operation state and results of the swivel control device 100. Here, the input part may include a physical key (for example, a physical button) and a soft key implemented on a touch display.

The output part may include a display, and further include a voice output part such as a speaker and a haptic module which generates vibrations. In this case, when a touch sensor such as a touch film, a touch sheet, or a touch pad is provided on the display, the display may operate as a touch screen, and the input part and the output part may be implemented in an integrated form.

The input/output interface 140 may be implemented as a physical button, a head-up display (HUD), a cluster, an audio video navigation (AVN) device, a human machine interface (HMI), a user setting menu (USM), or the like.

For example, the vehicle 10 may include a physical button on a door trim as an input part for requesting a seat swivel. Further, the vehicle 10 may receive an input or may output a screen through an audio video navigation (AVN) device in the first row of the vehicle, a display of a console located in the second or third row of the vehicle, or a display of an application implemented in a user terminal.

The input/output interface 140 may include an indicator. The indicator may at least visually display content related to the swivel operation on a physical button or a region adjacent to the physical button.

For example, the indicator may visually display an input which requests a partial swivel, a full swivel, or a return swivel to be described below and a state thereof by distinguishing the input and the state from each other, and in this case, may be configured as a light-emitting module including at least one light-emitting element (for example, a light-emitting diode (LED), or the like). Further, the indicator may be configured as an audio module or a haptic module capable of outputting sounds or vibrations, or may output sounds and vibrations which distinguish the inputs or states of the partial swivel, the full swivel, and the return swivel from each other. Accordingly, the user may intuitively distinguish the swivel input using the physical key without a display and recognize a current swivel driving state.

The sensor unit 150 may include at least one of a radio detection and ranging (RADAR) device, a light imaging detection and ranging (LIDAR) device, a camera, an ultrasonic sensor, and an infrared sensor. Further, the sensor unit 150 may include an indoor camera, an ultrasonic sensor, a seat sensor, and the like to detect an object in the vehicle.

The driver 160 may be configured to control the motor driving or engine driving of the vehicle 10, and may perform a function of controlling the driving of the components inside the vehicle. For example, the driver 160 may control a steering wheel, seats, a console, and the like to move, and may control the driving of each motor for this purpose. Further, the swivel driving of the seat of the vehicle 10 may be implemented in an electric type connected to a motor or the like, and may be automatically controlled through the driver 160.

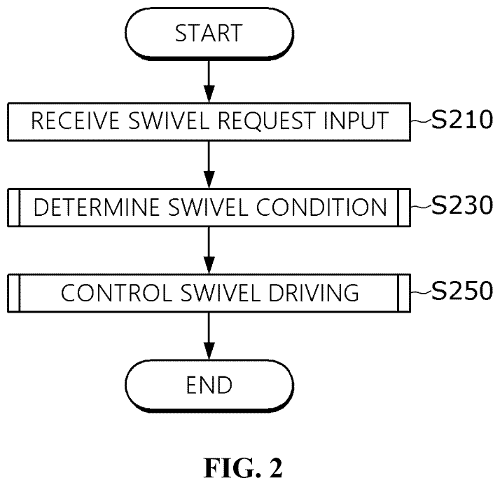

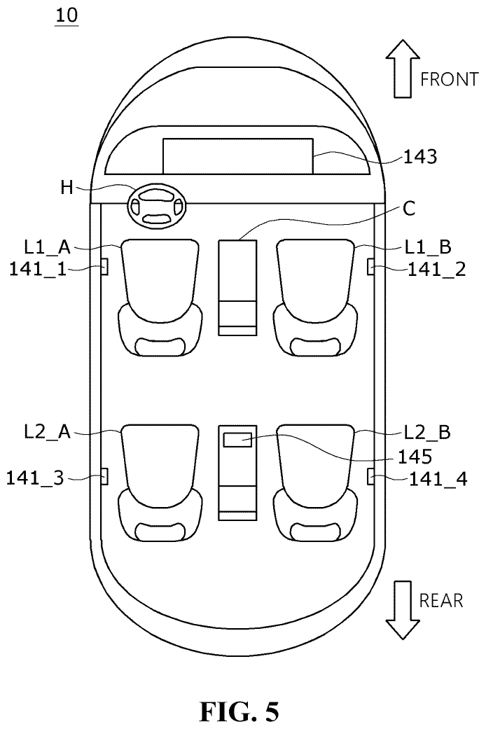

Hereinafter, the content of controlling the swivel driving of the vehicle seat will be specifically described with reference to FIGS. 2 to 4. FIGS. 2 to 4 will be described with reference to FIGS. 5 to 8. FIGS. 5 to 8 are exemplary views for describing the operation of the vehicle seat swivel.

The swivel control device 100 may receive a swivel request input (S210). The swivel request input may also be referred to as a requested swivel mode.

The swivel control device 100 may receive a swivel request input for at least one seat provided in the vehicle through the input/output interface 140. For example, the user may input a swivel request by pressing physical buttons 141_1 to 141_4 provided on a door trim in the vehicle 10 in FIG. 5. Further, the user may input the swivel request through at least one of a display 143 provided in front of the driver's seat, a display 145 provided in a second-row console box, and a display displayed according to the driving of the application of the user terminal.

The swivel request input may include at least one of a partial swivel input (also referred to as a partial swivel mode), a full swivel input (also referred to as a full swivel mode), and a return swivel input (also referred to as a return swivel mode).

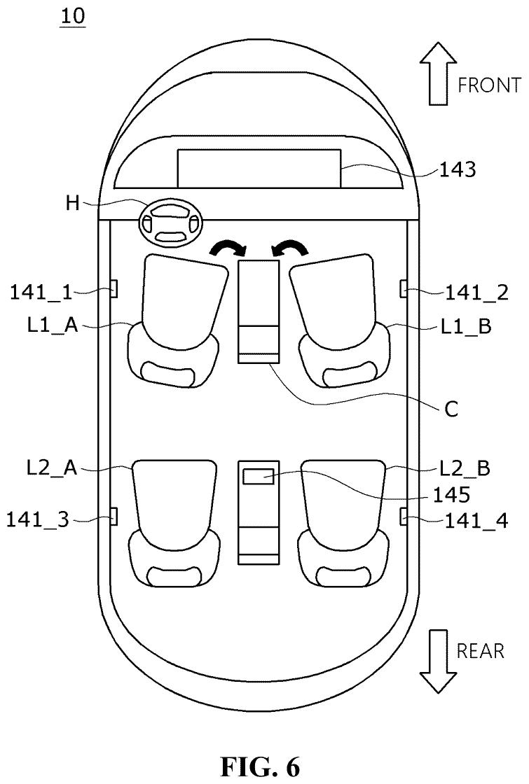

The partial swivel input means that a vertical shaft of the seat is rotated below a critical angle (also referred to as a threshold angle) in any one direction relative to the front of the vehicle (e.g., the front-facing direction). For example, as shown in FIG. 5, when partial swiveling is requested and operated in a state in which all seats face the front, seats L1_A and L1_B of the first row in FIG. 6 may be rotated below a certain critical angle. The driving in which the seat is partially swiveled by this partial swivel input is referred to as partial swivel driving hereinafter.

The critical angle which is the reference of the partial swivel may be set in various ways, but for example, may be set to 90 degrees, and the final angle driven by the partial swivel may be a state in which the vertical shaft of the seat is rotated about 10 to 20 degrees in any one direction. When the seat is swiveled inward toward the front display 143 as in the first row seats L1_A and L1_B in FIG. 6 by this angle, the users sitting on second row seats L2_A and L2_B may enjoy the content and the like played on the display 143 with a secured field of vision.

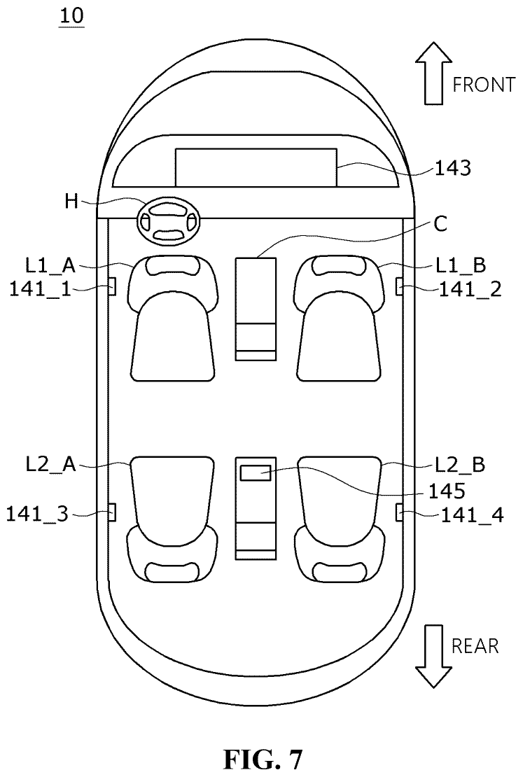

The full swivel input means that the vertical shaft of the seat is rotated by the critical angle or more in any one direction relative to the front of the vehicle (e.g., the front-facing direction). For example, as shown in FIG. 5, when the full swivel is requested and operated in a state in which all seats face the front, the seats may be rotated by a certain critical angle or more, as shown in the first row seats L1_A and L1_B in FIG. 7. The rotation of the seat to be fully swiveled by the full swivel input and to face a rear row of seats (for example, the second row or third row) will be referred to as full swivel driving.

The final angle driven by the full swivel may be, for example, a state in which the vertical shaft of the seat is rotated 180 degrees in any one direction from the state in which the seat faces the front of the vehicle. Due to this angle, the first row seats L1_A and L1_B in FIG. 7 are swiveled toward the rear to face the second row seats L2_A and L2_B. However, the first row seats do not have to be accurately rotated 180 degrees, and the first row seats may be rotated within a range that allows the seats to face the rear seats with a certain of error. Accordingly, the users sitting on the first row seats L1_A and L1_B may face and talk to the users sitting on the second row seats L2_A and L2_B.

The return swivel input means an input in which the seat of the vehicle 10 is rotated to face the front of the vehicle again when partially swiveled, fully swiveled, or rotated by an arbitrary angle. For example, as shown in FIGS. 6 and 7, the return swivel input may be an input in which the partially swiveled or fully swiveled seat returns to face the front again as shown in FIG. 5. The rotation of the seat to face the front of the vehicle by the return swivel input will be referred to as return swivel driving hereinafter.

The final angle rotated by the return swivel driving may be, for example, 0 degrees in a state in which the seat or the vertical shaft of the seat faces the front of the vehicle (e.g., the front-facing direction). However, the seat does not have to be accurately aligned at 0 degrees, and may be positioned within a range that allows the seat to face forward with a certain of error. Due to the return swivel driving, the driver may return to the original vehicle seat state and focus on driving.

The swivel control device 100 may display which swivel request input is received and which swivel driving is being controlled through the display in the vehicle 10 or an application screen running on the user terminal. That is, in response to reception of the above three inputs, content such as text, audio, an image, and a video corresponding to the three inputs may be distinguished and displayed through the display.

A physical button for inputting the swivel driving may be provided in a partially limited form according to a manufacturing policy for minimizing the number of buttons. In this case, when the swivel request is input through the physical button, the swivel control device 100 may check the current state of the requested seat to control the swivel operation of the seat.

For example, when the physical button is implemented as one button having both the full swivel input and the return swivel input, the swivel control device 100 may check the current state of the seat related to the corresponding button and determine whether to drive the requested seat in a full swivel sequence or return swivel sequence when the corresponding button is pressed. When the corresponding seat is currently in the return state as a first row seat (that is, the state facing the front), the swivel control device 100 may fully swivel the corresponding seat to control the swivel driving toward a second row seat, that is, the rear of the vehicle.

When the first row seat is currently in the partial swivel state or in a state in which rotation is stopped at an arbitrary angle due to an unintended operation, the swivel control device 100 may rotate the first row seat in a return sequence so that the first row seat may face the front even when the full swivel button is pressed. Next, after a certain time has elapsed, automatically or when the full swivel physical button is detected to be pressed again, the first row seat may be fully swiveled toward the rear.

The swivel control device 100 may check whether the physical button, through which the swivel input was received, is a button in a driver's seat region (e.g., a driver-side button) or a button in a passenger's seat region (e.g., a passenger-side button), and control the satisfaction range of the swivel condition or the swivel driving of the seat included in the vehicle differently according to the checked button position.

For example, the swivel driving of at least one of the driver's seat and the passenger's seat in the first row may be requested through a first physical button 141_1 located at the driver's seat in the first row. In this case, a second physical button 141_2 located at the passenger's seat in the first row may request the swivel driving only for the passenger's seat in the first row. However, the present disclosure is not limited thereto, and a seat to be swiveled may be selected through an arbitrary physical button without limitation.

The input through the physical button and the input through the display may conflict, or the physical button may be input during the swivel operation. For example, when the input through the physical button and the input through the display overlap within a certain relatively short time, the physical button may be input during the swivel driving. In this case, the swivel control device 100 may recognize or preferentially process only the input through the physical button so that the user may intuitively operate through the physical button in various environments and variables according to the swivel driving.

The swivel input through the touchscreen display may be implemented so that the partial swivel input, the full swivel input, and/or the return swivel input are all possible. When the swivel input is received through the display, the swivel control device 100 may control the full swivel driving or the return swivel driving in the partial swivel state, and may also drive from the full swivel state to the partial swivel state. That is, the swivel driving states may be freely switched from one state to another state.

Meanwhile, although swivel driving may be immediately performed when the above-mentioned various swivel requests are input, the swivel driving is performed when a certain swivel condition for the swivel driving is satisfied.

Referring to FIG. 2 again, when the swivel request input is received, the swivel control device 100 may determine the swivel condition (S230).

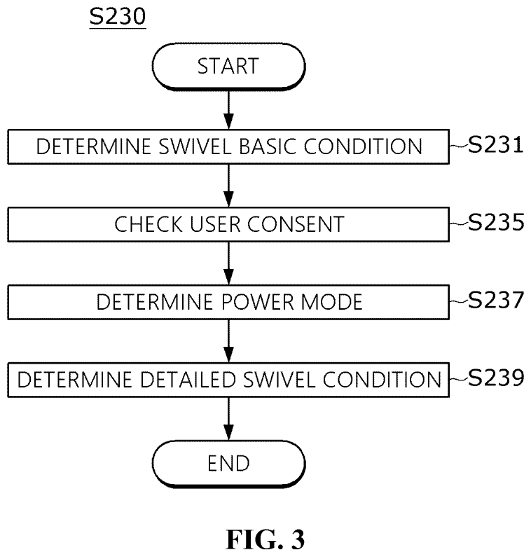

Specific operations of operation S230 in FIG. 2 are disclosed in FIG. 3, and FIG. 3 is a flowchart of a process of determining a seat swivel condition.

When the swivel request input is received through the input/output interface 140, first, the swivel control device 100 may determine whether a basic condition of the swivel is satisfied (S231). The swivel basic condition may include at least one of a gear position of the vehicle, a speed of the vehicle, and a power ON/OFF state of the vehicle.

For example, when the swivel request input is requested, the swivel control device 100 may check whether the gear position of the vehicle is a specific gear position (e.g., park, drive, reverse, neutral, etc.), whether the vehicle is not in a power-off state, or whether the vehicle is stopped or is at a speed below a certain value. For example, the swivel driving should not be in the power-off state, and the vehicle should be stopped or at a speed below the certain value. Further, the gear should be in a parking state.

When all of these states are not satisfied, the swivel driving may not start, but when at least one of the above conditions is satisfied according to the manufacturer's policy or a user's setting, it may be determined that the basic condition is satisfied.

For example, when the partial swivel request is input, the swivel control device 100 does not determine whether the speed is below a certain value which is at least a part of the basic conditions. That is, the partial swivel driving may be possible during driving.

Meanwhile, the swivel control device 100 may notify the result of the determined basic condition to the user through the input/output interface 140. For example, the swivel control device 100 may display a message which indicates that a current P gear setting is required for the swivel request through the display 143 at the front of the vehicle. Accordingly, the user may take an action to change the gear to the P gear to satisfy the basic condition.

When the basic condition is satisfied, the swivel control device 100 may check the user's consent (S235).

When the swivel driving is performed, the operation of some components related to safety such as a vehicle airbag may be limited. In this case, since a liability issue may occur when an accident occurs, the swivel control device 100 may caution or warn the user in advance by collecting the user's consent for the swivel driving operation.

The collection of this user consent may be performed through various components of the input/output interface 140. For example, the swivel control device 100 may request the user consent for the swivel driving through at least one of the displays provided in the vehicle or a screen guided through an application of the user terminal.

After the user consent is acquired, the vehicle may not acquire an additional user consent according to an additional swivel driving input for a certain time (for example, 3 minutes). That is, the user consent confirmation procedure is omitted for the additional swivel driving input within a certain time. This state is referred to as a user consent state.

The above user consent confirmation process may be omitted for the return swivel input among the swivel request inputs.

The above user consent state may be deactivated by a specific event. For example, the swivel basic condition of operation S231 in FIG. 3 may be determined again according to the swivel request of another additional seat. When the corresponding basic condition is not satisfied, the swivel control device 100 may delete the user consent state or previous user consent information related thereto to receive the consent information again for safety when the basic condition such as P gear or vehicle speed is not satisfied.

When a user input which indicates that the user does not consent to the swivel driving is received or is considered not to consent (for example, a user input which indicates that the user consents to the swivel driving is not received within the certain time), the swivel control device 100 may stop or suspend the swivel driving sequence. In this case, the swivel control device 100 may display information which indicates that the user consent has not been acquired through the display.

When an input which indicates consent is received, the input is in the user consent state, or the input of the user consent is omitted, the swivel control device 100 may check whether the power mode of the vehicle is a power mode for the swivel sequence (S237).

In vehicles, specifically, electric vehicles, power modes may be variously set according to the manufacturer. For example, the power mode in an electric vehicle (also referred to as an electric vehicle power mode) may include power modes such as an ignition off mode, a power on mode, a ready mode, a utility mode, and the like. These power modes may be entered according to a power button operation in a state in which a brake is pressed/not pressed, a selection on a user setting screen, and the like.

Power management providing a specific voltage or more is required for the seat swivel driving. For example, the swivel sequence may be performed in a specific mode, for example, a utility mode. The utility mode may mean, for example, a power control state in which alternating current (AC) power in a 110 V to 240 V range is output in an electric vehicle model. The range of the voltage may vary depending on the type of vehicle and the like, and is not limited to a specific voltage value.

When the power mode of the vehicle is not a specific power mode (for example, the utility mode) providing a predetermined voltage value for the swivel sequence, the swivel control device 100 may stop or suspend the swivel sequence. Further, even in this case, the content that the specific power mode is not satisfied may be displayed to the user through the display.

The swivel control device 100 may transition to the specific power mode (for example, the utility mode) for the swivel sequence automatically or through a user input instead of stopping or suspending the swivel driving sequence as described above.

When the transition to the specific power mode is not performed according to a preset policy, the swivel control device 100 may stop the swivel driving. In this case, the swivel control device 100 may provide feedback information which indicates that a change in power mode has not been performed to the user through the display.

Meanwhile, when the swivel request input is the return swivel input, the swivel control device 100 may omit the determination of the power mode.

When the power mode of the vehicle is in a power management state (for example, the utility mode) providing a predetermined voltage value for the swivel sequence, when the change to a specific power mode is completed, or when the determination of the power mode is omitted, the swivel control device 100 may determine the detailed swivel condition (S239).

The detailed swivel condition may include at least one of a seating state of the seat (e.g., a seating position, a state indicating whether an occupant is present on the seat, etc.), an existing operation state (e.g., a previous operation state) of the seat, and a pre-driving condition of the seat swivel (e.g., a preliminary condition of the seat before the swivel operation).

For example, when the full swivel input is requested, the swivel input may not be driven when the user is seated on the corresponding seat because the user may be caught in a specific space or injured in the swivel driving process. In this sense, when the partial swivel input is requested, the partial swivel driving may be performed even when the user is sitting on the corresponding seat.

Further, the existing operation state of the seat for which the swivel input is requested may be determined as a detailed condition. For example, when other operations such as forward and backward movement adjustment and reclining adjustment of the seat are already operated through manual input in the specific seat for which the swivel input is requested, the swivel driving may be restricted to reflect the user's will for requesting a specific operation for the seat.

Further, the pre-driving condition of the seat swivel may be determined as a detailed condition. For example, when the specific seat for which the swivel input is requested rotates, interference or collision with a surrounding object may occur.

Specifically, when the full swivel input is requested or when the return swivel input is requested in the full swivel state, the swivel control device 100 may control the full swivel driving after moving the steering wheel, the console, the door trim, and the corresponding seat to a specific position in advance. To this end, a distance between the seat and an adjacent object may be checked at a specific time point, or information on an object to be moved in advance according to a pre-driving policy may be stored in a database (DB) in advance. In this case, a position of not only the adjacent object but also the seat itself may be moved. For example, a specific rail position toward the front/rear of the seat, a specific folding angle of the seat, and the like may be designated as targets to be pre-driven.

Meanwhile, when the certain time has passed or in a specific case such as power being unintentionally turned off, the above-described basic condition of S231 may be checked again when the swivel detailed condition is determined.

The swivel driving may be possible only when all of the above-described conditions of each operation in FIG. 3 are satisfied in step by step, but it may be determined that the swivel condition is satisfied even when only at least some of the conditions of each operation in FIG. 3 are satisfied. As described above, the swivel control device 100 may apply a satisfaction range of the swivel condition differently according to which input is requested among the partial swivel input, the full swivel input, and the return swivel input.

Further, the swivel control device 100 may distinguish the input through the display and the input through the physical button to apply the satisfaction range of the swivel condition differently.

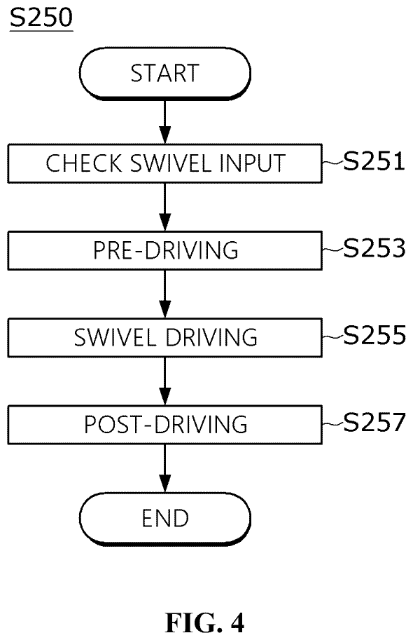

When at least some of the various conditions in FIG. 3 are satisfied according to the type of swivel request input, the swivel control device 100 may control the swivel driving (S250). In FIG. 4, specific operations of operation S250 in FIG. 2 will be disclosed.

Specifically, the swivel control device 100 may check the swivel input (S251).

The swivel control device 100 may check which swivel request is input according to each of the conditions in FIG. 3 described above. Only at least some of the operations in FIG. 4 may be activated according to the checked swivel request input.

In the case of a swivel input that requires preliminary movement, for example, when the full swivel is requested or the return swivel input is requested from a fully swiveled state, the swivel control device 100 may perform preliminary movement (e.g., also referred to as preliminary adjustment or pre-driving) (S253). However, the present disclosure is not limited thereto, and even when the partial swivel input is requested, the swivel control device 100 may determine the position of an adjacent object and control the preliminary movement of the object or the seat when there is an issue of interference.

Preliminary movement may refer to changing the positions of seats or components which may interfere in the process of swiveling the seat of the vehicle 10 in advance (e.g., before the swiveling is initiated). That is, the preliminary movement may be a preprocessing operation of allowing an object which may collide or interfere at an arbitrary angle among the rotation section of the seat according to the swivel to move in advance. Whether this preliminary movement is in progress may be determined when the above-described swivel detailed condition is determined, but may also be determined again at any time point.

The swivel control device 100 may move (e.g., move linearly, laterally, longitudinally, diagonally, etc.) at least one of one or more objects adjacent (e.g., a steering column, a steering wheel, a gear shifter, a hand brake, a console, a receptacle, a seatbelt buckle assembly, another seat, etc.) to the seat and/or the seat from an existing position (also referred to as an original position or a starting position) to a first position in the swivel process of the seat.

For example, when at least some of the seats L1_A, L1_B, L2_A, and L2_B in FIG. 5 is swiveled as shown in FIG. 6 or 7, the swivel control device 100 may move a position of an object of a steering wheel H, a console C, a door trim or the seats L1_A, L1_B, L2_A, and L2_B from the existing position to the first position. The first position may mean, for example, a position corresponding to a specific threshold value that does not interfere with the corresponding object even when the seat is rotated, and not only the position of the seat itself, but also the motion such as the configuration of the object partially tilting or folded upward and downward or the like may be interpreted as the position of the specific threshold value.

Specifically, when a target of the swivel request input includes at least the driver's seat in the first row of vehicle, the swivel control device 100 may perform preliminary movement at least one of the steering wheel (handle) and a component (for example, an accessory for speed or gear control) integrally formed with a region adjacent to the steering wheel or the steering wheel.

The swivel control device 100 may identify the positions of various objects inside the seat or the vehicle 10 through the sensor unit 150 for the above preliminary movement process. Based on the time point of identification, when the existing object position is a position which does not require preliminary movement, the swivel control device 100 may not move the object, and when the existing object position is a position which requires preliminary movement, the swivel control device 100 may control the object to move.

When the preliminary movement is completed or the preliminary movement is not necessary, the swivel control device 100 may control the swivel movement of the seat corresponding to the requested input (S255).

The swivel control device 100 may control the swivel movement in a specific sequence of the partial swivel, the full swivel, and the return swivel for at least some of the swivel-requesting seats among the seats provided in the vehicle 10.

Next, the swivel control device 100 may control any post-swivel movement (also referred to as post-swivel adjustment) (S257).

In order to prevent an issue such as interference in the swivel rotation process, the seat or the object in the vehicle 10 may be moved to a position that is somewhat inconvenient for the user to use while going through the above-described preliminary movement or swivel driving.

For example, since a backrest of the seat should move forward by a position corresponding to a threshold value during the swivel rotation, a state in which it is difficult for a person to sit may appear after the swivel rotation is completed. Accordingly, after the swivel rotation is completed, the swivel control device 100 should perform post-swivel movement to post-process the position of the seat or object so that the user may sit or use it again.

To this end, after the swivel operation of the seat is completed, the swivel control device 100 may move at least one of one or more objects and the seat in the vehicle 10 from the first position to a second position. In this case, the second position may be any point in a section in which the at least one of the one or more objects and the seat has been moved from the above-described existing position to the first position. In other words, the second position may be between the existing position and the first position.

That is, when the object or the seat is moved by the first position from the existing position for the swivel rotation, the second position may be a position returning to any point in the section returning to the existing position again. Accordingly, as the excessively moved seat or the like is corrected to the existing position to some extent, the user may conveniently use the seat or the like.

Meanwhile, all of the above-described operations in FIG. 4 may be performed, but only some of the driving operations in FIG. 4 may be performed.

The swivel control device 100 may control the swivel driving of the seat included in the vehicle differently according to which input is requested among the partial swivel input, the full swivel input, and the return swivel input. For example, when the partial swivel input is requested, the above post-swivel movement may be omitted.

Operations of the above-described preliminary movement, swivel driving, and post-swivel movement are equally applicable to the return swivel operation. For example, when each operation in FIG. 4 is completed by the full swivel sequence up to the post-swivel movement, the driving of the seat or objects may be controlled in the reverse order of the operation performed by the full swivel sequence when the return swivel sequence is performed in the future. In this case, when the swivel condition in FIG. 3 is determined to be driven in the return swivel sequence, some conditions (for example, user consent, power mode determination, and the like) for the conventional full swivel sequence may be omitted.

Meanwhile, as in the above-described swivel condition, the swivel control device 100 may distinguish the input through the display and the input through the physical button to control the swivel driving of the seat included in the vehicle differently. For example, priority processing of the physical button operation, input conditions for driving the full swivel and the return swivel, and the like may be distinguished and controlled.

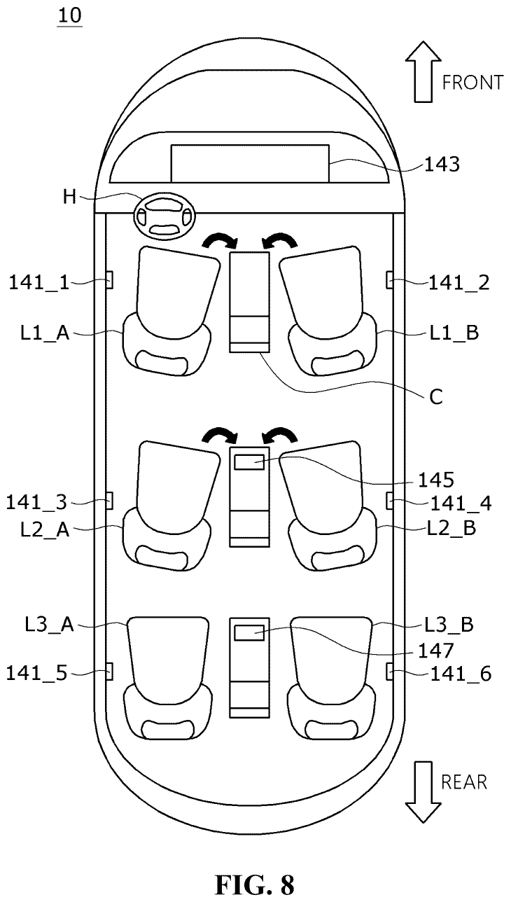

Meanwhile, the swivel driving control of the seat is not limited to a specific row. For example, the swivel control device 100 may control the swivel driving for at least some of the seats L1_A, L1_B, L2_A, L2_B, L3_A, and L3_B of the vehicle 10 provided in the first row, the second row, and the third row as shown in FIG. 8. In this case, physical buttons 141_3 to 141_6 and the displays 145 and 147 may be provided in the second or third row. As shown in FIG. 8, as both the first and second rows of seats are partially swiveled, users on all of the seats may view the display 143 in front from a more secured field of view. Further, although not shown in the drawings, the first row seats L1_A and L1_B in FIG. 8 may be completely swiveled to face the rear, and the second row seats L2_A and L2_B and the third row seats L3_A and L3_B may be partially swiveled. Accordingly, the users seated on the second row and third row seats may have a conversation or conduct a meeting while looking at the users seated on the first row seat.

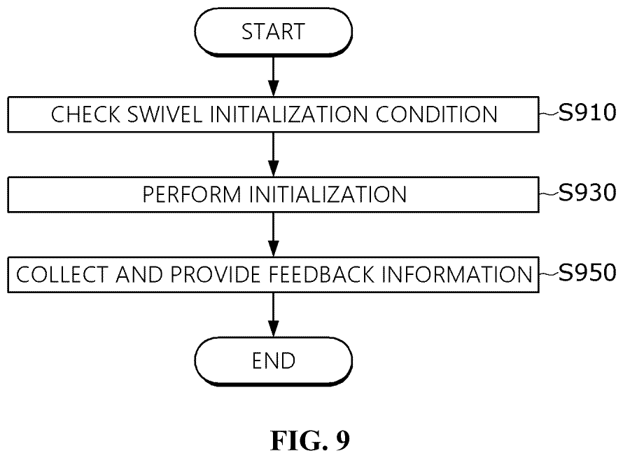

FIG. 9 is a flowchart illustrating a swivel initialization process.

Swivel initialization means a driving procedure for correcting a swivel angle of the seat again when the swivel angle is not driven at the specified angle due to repeated swivel driving and an error continuously occurs.

The swivel control device 100 may check a swivel initialization condition (S910). The swivel initialization condition may be performed by user input, but the swivel initialization may be automatically and continuously performed after an initialization mode of an existing inherent function preset for the corresponding seat is performed.

For example, the electric seat may be initialized for a rail position of the electric seat in consideration of a certain condition, for example, whether the gear is a P gear. After the conventional initialization condition of the seat is completed, subsequently, the swivel control device 100 may perform the swivel initialization (S930).

In the swivel initialization operation, for example, the initialization is performed while the swivel control device 100 rotates a full swivel point (for example, 180 degrees) from an initial point (for example, 0 degrees) at which the swivel rotation is possible, and then returns to the initial point. That is, in a process of moving the swivel angle from one end to the other, since the current position is learned by a motor or the like, the initialization is performed.

Next, the swivel control device 100 may collect feedback information according to the initialization and provide information such as completion of initialization progress for the feedback information to the user through the display (S950).

It may be possible to more stably provide the seat swivel function to the user by automatically controlling the swivel driving of the seat in consideration of various conditions of the vehicle.

The term “unit” used in one or more example embodiments may refer to a software and/or hardware component such as a field-programmable gate array (FPGA) or an application-specific integrated circuit (ASIC), and the “unit” may perform certain roles. However, the “˜unit” is not limited to software or hardware. The “unit” may be configured to be on an addressable storage medium or may be configured to play one or more processors. Accordingly, for example, the “unit” includes components such as software components, object-oriented software components, class components, and task components, processes, functions, attributes, procedures, subroutines, segments of program code, drivers, firmware, microcode, circuits, data, databases, data structures, tables, arrays, and variables. The functions provided in the components and the “units” may be combined into a smaller number of components and “units” or may be further separated into additional components and “-units”. In addition, the components and “units” may be implemented to play one or more CPUs in a device or a secure multimedia card.

A vehicle may include an input/output interface; and a swivel control device that receives a swivel request input for at least one seat included in the vehicle through the input/output interface and controls the swivel driving of the seat when a swivel condition is satisfied.

The swivel condition may include at least one of a gear position of the vehicle, a speed of the vehicle, a power on/off state of the vehicle, whether the vehicle is in a specific power mode among power modes supported by an electric vehicle, a user consent state for swiveling, a sitting state of the seat, an existing operation state of the seat, and a pre-driving condition of the seat swivel.

The swivel request input may include at least one of: a partial swivel input in which a vertical shaft of the seat is rotated below a critical angle in any one direction based on the front of the vehicle; a full swivel input in which the seat is rotated by the critical angle or more; and a return swivel input in which the seat is rotated to face the front of the vehicle.

The swivel control device may apply a satisfaction range of the swivel condition differently according to which input is requested among the partial swivel input, the full swivel input, and the return swivel input.

The swivel control device may control the swivel driving of the seat differently according to which input is requested among the partial swivel input, the full swivel input, and the return swivel input.

The swivel driving of the seat may include at least one of a seat to be swiveled among the seats included in the vehicle and a rotation angle of the seat.

If the swivel request input is the full swivel input or the return swivel input, the swivel control device may move at least one of one or more objects adjacent to the seat and the seat from an existing position to a first position in a swivel process of the seat before a swivel operation of the seat.

At least one of the one or more objects and the seat may be moved from the first position to a second position after the swivel operation of the seat is completed, and the second position may be any point in a section in which the at least one of the one or more objects and the seat has been moved from the existing position to the first position.

The seat may include at least a driver's seat in a first row of the vehicle, and the object may include at least one of a steering wheel and a component configured in a region adjacent to the steering wheel.

The input/output interface may include at least one of a touchable display and a physical button, and the swivel control device may distinguish an input through the display and an input through the physical button to control a satisfaction range of the swivel condition or the swivel driving of the seat included in the vehicle differently.

The swivel control device may check whether the swivel input through the physical button is a button of a driver's seat region or a button of a passenger's seat region, and control the satisfaction range of the swivel condition or the swivel driving of the seat included in the vehicle differently according to the checked button position.

The vehicle may further include an indicator that at least visually displays content related to a swivel operation on the physical button or a region adjacent to the physical button.

A control method of controlling the swivel driving of a vehicle seat may include: receiving a swivel request input for at least one seat included in a vehicle through an input/output interface of the vehicle; checking whether the swivel request input satisfies a swivel condition; and controlling the swivel driving of the seat when the swivel condition is satisfied.

If the swivel request input is a full swivel input or return swivel input, the controlling of the swivel driving of the seat may include moving at least one of one or more objects adjacent to the seat and the seat from an existing position to a first position in a swivel process of the seat, before a swivel operation of the seat.

The controlling of the swivel driving of the seat may further include moving at least one of the one or more objects and the seat from the first position to a second position after the swivel operation of the seat is completed, and the second position may be any point in a section in which the at least one of the one or more objects and the seat has been moved from the existing position to the first position.

The input/output interface may include at least one of a touchable display and a physical button, the checking of whether the condition is satisfied may include distinguishing an input through the display and an input through the physical button to determine a satisfaction range of the swivel condition differently, and the controlling of the swivel driving of the seat may include distinguishing the input through the display and the input through the physical button to control the swivel driving of the seat differently.

As the swivel driving of a seat is automatically controlled in consideration of various conditions of a vehicle, a seat swivel function can be more stably provided to a user.

In addition, since the seat swivel angle can be partially or fully controlled, a seat swivel environment suitable for various situations can be provided.

The effects of the present disclosure are not limited to the effects mentioned above, and other effects not mentioned will be clearly understood by those skilled in the art from the following description.

Although described above with reference to example embodiments of the present disclosure, those skilled in the art will understand that the present disclosure may be variously modified and changed within the scope not departing from the spirit and scope of the present disclosure described in the following claims.

What is claimed is:

1. A vehicle comprising:
at least one seat capable of swiveling;
a user interface; and
a swivel control device configured to:
receive, via the user interface, an indication of a requested swivel mode for the at least one seat; and
control, based on the requested swivel mode and based on a detection of a swivel condition being satisfied, a swivel operation of the at least one seat.

2. The vehicle of claim 1, wherein the swivel condition comprises at least one of: autonomous driving of the vehicle, a detection of a collision risk of the vehicle with an external object, a gear position of the vehicle, a speed of the vehicle, a power on or off state of the vehicle, an electric vehicle power mode of the vehicle, a user consent state for swiveling, a seating state of the at least one seat, a previous operation state of the at least one seat, or a preliminary condition of the at least one seat before the swivel operation.

3. The vehicle of claim 2, wherein the requested swivel mode comprises at least one of:
a partial swivel mode for rotating the at least one seat, around a vertical shaft of the at least one seat, by an angle, below a threshold angle, in any one direction relative to a front-facing direction;
a full swivel mode for rotating the at least one seat by at least the threshold angle; or
a return swivel mode for rotating the at least one seat in the front-facing direction.

4. The vehicle of claim 3, wherein the swivel condition is different for the partial swivel mode, the full swivel mode, and the return swivel mode.

5. The vehicle of claim 3, wherein the swivel control device is configured to control the swivel operation by controlling the swivel operation of the at least one seat differently for the partial swivel mode, the full swivel mode, and the return swivel mode.

6. The vehicle of claim 5, wherein the swivel control device is configured to control the swivel operation of the at least one seat by at least one of:
determining, among the at least one seat, a seat to be swiveled, or
determining a rotation angle for swiveling the at least one seat.

7. The vehicle of claim 3, wherein the swivel control device is configured to control the swivel operation of the at least one seat by:
moving, before the swivel operation of the at least one seat starts and based on the requested swivel mode being one of the full swivel mode or the return swivel mode, the at least one seat or one or more objects adjacent to the at least one seat from a starting position to a first position.

8. The vehicle of claim 7, wherein the swivel control device is configured to control the swivel operation of the at least one seat further by:
moving, after the swivel operation of the at least one seat is complete, the at least one seat or the one or more objects from the first position to a second position, and
wherein the second position is between the starting position and the first position.

9. The vehicle of claim 7, wherein the at least one seat comprises a driver's seat in a first row of the vehicle, and
wherein the one or more objects comprise at least one of a steering wheel or a component disposed in a region adjacent to the steering wheel.

10. The vehicle of claim 1, wherein the user interface comprises at least one of a touch screen or a physical button, and
wherein at least one of the swivel condition or the swivel operation being controlled is different based on whether the requested swivel mode is received via the touch screen or the physical button.

11. The vehicle of claim 10, wherein at least one of the swivel condition or the swivel operation being controlled is different based on whether the physical button, via which the requested swivel mode is received, is a driver-side button or a passenger-side button.

12. The vehicle of claim 10, further comprising an indicator configured to visually display content related to the swivel operation, wherein the indicator is disposed on the physical button or in a region adjacent to the physical button.

13. A method performed by an apparatus of a vehicle, comprising:
receiving, via a user interface of the vehicle, an indication of a requested swivel mode for at least one seat of the vehicle, wherein the at least one seat is capable of swiveling;
controlling driving of the vehicle; and
controlling, based on the requested swivel mode and based on a detection of a swivel condition being satisfied, a swivel operation of the at least one seat.

14. The method of claim 13, wherein the swivel condition comprises at least one of: autonomous driving of the vehicle, a detection of a collision risk of the vehicle with an external object, a gear position of the vehicle, a speed of the vehicle, a power on or off state of the vehicle, an electric vehicle power mode of the vehicle, a user consent state for swiveling, a seating state of the at least one seat, a previous operation state of the at least one seat, or a preliminary condition of the at least one seat before the swivel operation.

15. The method of claim 14, wherein the requested swivel mode comprises at least one of:
a partial swivel mode for rotating the at least one seat, around a vertical shaft of the at least one seat, by an angle, below a threshold angle, in any one direction relative to a front-facing direction;
a full swivel mode for rotating the at least one seat by at least the threshold angle; or
a return swivel mode for rotating the at least one seat in the front-facing direction.

16. The method of claim 15, wherein the swivel condition is different for the partial swivel mode, the full swivel mode, and the return swivel mode.

17. The method of claim 15, wherein the controlling of the swivel operation comprises controlling the swivel operation of the at least one seat differently for the partial swivel mode, the full swivel mode, and the return swivel mode.

18. The method of claim 15, wherein the controlling of the swivel operation comprises:
moving, before the swivel operation of the at least one seat starts and based on the requested swivel mode being one of the full swivel mode or the return swivel mode, the at least one seat or one or more objects adjacent to the at least one seat from a starting position to a first position.

19. The method of claim 18, wherein the controlling of the swivel operation further comprises:
moving, after the swivel operation of the at least one seat is complete, the at least one seat or the one or more objects from the first position to a second position, and
wherein the second position is between the starting position and the first position.

20. The method of claim 13, wherein the user interface comprises at least one of a touch screen or a physical button,
wherein at least one of the swivel condition or the swivel operation being controlled is different based on whether the requested swivel mode is received via the touch screen or the physical button, and
wherein at least one of the swivel condition or the swivel operation being controlled is different based on whether the physical button, via which the requested swivel mode is received, is a driver-side button or a passenger-side button.
